(19) United States
(12) Patent Application Publication
(10) Pub. No.: US 2025/0298256 A1
(43) Pub. Date: Sep. 25, 2025

(54) METHOD FOR PROJECTING IMAGE CONTENTS ONTO THE RETINA OF A USER

(71) Applicant: Robert Bosch GmbH, Stuttgart (DE)

(72) Inventors: Johannes Meyer, Haseluenne (DE); Thomas Alexander Schlebusch, Renningen (DE); Johannes Fischer, Pliezhausen (DE)

(21) Appl. No.: 18/860,995

(22) PCT Filed: Jul. 13, 2023
(86) PCT No.: PCT/EP2023/069446

§ 371 Date: Oct. 28, 2024

(30) Foreign Application Priority Data
Oct. 5, 2022 (DE) 10 2022 210 500.1

(51) Int. Cl. G02B 27/01; G02B 27/00

(52) U.S. Cl. CPC G02B 27/0179; G02B 27/0012; G02B 27/0081; G02B 27/0093; G02B 27/0172; G02B 2027/0174; G02B 2027/0178; G02B 2027/0187

(57) ABSTRACT

An optical system for a virtual retinal scan display. A plurality of first exit pupils and replicated, second exit pupils are produced. A computing unit is designed, depending on second light beams, backscattered by an outer eye surface and detected using a first sensor, in a first infrared wavelength range or the modulation of the power of a second light source, and/or depending on third light beams, backscattered by the outer eye surface, in a second infrared wavelength range or a modulation of a power of a third light source and/or depending on backscattered third light beams detected using a second sensor, or the modulation of the power of the third light source, to ascertain the positions of the first exit pupils relative to a pupil center and the positions of the second exit pupils relative to the pupil center.

### FIELD

The present invention relates to an optical system for a virtual retinal scan display. In addition, the present invention relates to a method for projecting image contents onto the retina of a user.

### BACKGROUND INFORMATION

A multi-eyebox retina scan system is described in U.S. Pat. No. 10,254,547 B2. In this case, the positions of the plurality of exit pupils are ascertained depending on the detected light beams backscattered by the eye. In addition, it is ascertained which exit pupil is currently aligned the best relative to the eye.

It is an object of the present invention to develop an optical system for a virtual retinal scan display, which makes ascertaining the different positions of the exit pupils relative to the pupil center possible even when if the exit pupils are replicated.

### SUMMARY

For achieving the object, an optical system for a virtual retinal scan display having features of the present invention is provided. In addition, a method for projecting image contents onto the retina of a user having features of the present invention is provided.

According to an example embodiment of the present invention, the optical system comprises an image source, which provides image content in the form of image data, and an image processing device for the image data. The optical system additionally comprises a projector unit with a time-modulatable first light source for generating at least one, in particular visible, first light beam and with a controllable deflection device for the at least one first light beam for scanning projection of the image content. The deflection device is in particular a micromirror mounted rotatably about a first and/or second axis of rotation. The projector unit furthermore compromises a second light source for generating at least one second light beam in a first infrared wavelength range. The controllable deflection device is designed in this context to deflect the at least one second light beam in a scanning manner. Alternatively or additionally, the projector unit comprises a third light source for generating at least one third light beam in a second infrared wavelength range different from the first infrared wavelength range. In this context as well, the controllable deflection device is designed to deflect the at least one third light beam in a scanning manner. In addition, the optical system comprises a redirection unit, onto which the image content is projectable and which is configured to direct the projected image content and the second light beams toward an eye of a user. The optical system furthermore comprises an optical segmentation element, which is arranged between the projector unit and the redirection unit and with the aid of which the image content and the second light beams are projectable via different imaging paths onto at least one projection area of the redirection unit so that, in particular at different times, a plurality of spatially-offset first exit pupils is produced. Alternatively or additionally, with the aid of the optical segmentation element, the third light beams are projected via different imaging paths onto the at least one projection area of the redirection unit so that, in particular at different times, the plurality of spatially-offset first exit pupils is produced. The optical segmentation element is in particular an optical segmentation lens. The optical system furthermore comprises an optical replication component, which is arranged in the at least one projection area of the redirection unit and is configured to direct the projected image content in a replicated manner toward the eye of the user so that, in particular at different times, a plurality of spatially-offset second, replicated exit pupils is produced with the image content. The optical replication component is additionally designed to direct the second light beams in a replicated manner toward the eye of the user. Alternatively or additionally, the optical replication component is designed to direct the third light beams toward the eye of the user. In addition, the optical system comprises a first sensor designed to detect second light beams backscattered by an outer eye surface, in particular the iris or sclera, of the user, or a modulation of a power, in particular a laser power, of the second light source. Alternatively or additionally, the first sensor is suitable for detecting third light beams backscattered by the outer eye surface, or a modulation of a power, in particular a laser power, of the third light source. Alternatively or additionally, the optical system furthermore comprises a second sensor designed to detect the third light beams backscattered by the outer eye surface, or the modulation of the power, in particular the laser power, of the third light source. In addition, the optical system comprises a computing unit designed to ascertain the, in particular different, positions of the first exit pupils relative to a pupil center and the, in particular different, positions of the second exit pupils relative to the pupil center, depending on the backscattered second light beams detected by means of the first sensor or on the modulation of the power of the second light source. Alternatively or additionally, the computing unit is used to ascertain the positions of the first exit pupils relative to a pupil center and the positions of the second exit pupils relative to the pupil center, depending on the backscattered third light beams detected by means of the second sensor or on the modulation of the power of the third light source. Furthermore, the computing unit is used to differentiate the ascertained positions of the ascertained first exit pupils relative to the pupil center from the ascertained positions of the ascertained second exit pupils relative to the pupil center, in particular for image processing. This means that, as a result of the computational operations, the ascertained positions of the first exit pupils are clearly differentiated from the ascertained positions of the second exit pupils. This differentiation can, for example, be made via different tables or different outputs of the computing unit. Preferably, this differentiation of the ascertained positions is carried out through the signal evaluation of the sensor data detected by means of the first and/or second sensor. In a simple replication, the first and second exit pupils are produced simultaneously as pairs A, A′ or B, B′ and can result in double images when simultaneously imaged on the retina of the user. Differentiating the positions of the first exit pupils from the positions of the second exit pupils can prevent confusion, in particular ambiguities, in the subsequent image processing by means of the image processing device.

According to an example embodiment of the present invention, preferably, the computing unit is designed, in particular only, to ascertain the positions of the first and second exit pupils that impinge on a retina of the user at the time of detecting the backscattered second light beams or the modulation of the power of the second light source. Alternatively or additionally, the computing unit is used to ascertain the positions of the first and second exit pupils that impinge on the retina of the user at the time of detecting the backscattered third light beams or the modulation of the power of the third light source. Only the positions of the first and second exit pupils that can actually result in double images for the user are thus ascertained and differentiated from one another. Other exit pupils are, for example, blocked by the iris and thus do not reach the retina of the user at all. Preferably, the computing unit is furthermore designed to ascertain a respective portion of the first and second exit pupils that impinges on the retina of the user at the time of detecting the backscattered second light beams or the modulation of the power of the second light source. Alternatively or additionally, the computing unit is used to ascertain a respective portion of the first and second exit pupils that impinges on the retina of the user at the time of detecting the backscattered third light beams or the modulation of the power of the third light source. It is thus possible to differentiate even more precisely between first and second exit pupils or their portions that can actually result in double images.

According to an example embodiment of the present invention, preferably, the computing unit is designed to represent the ascertained position of a first exit pupil, in particular of the plurality of first exit pupils, differently in an image than an ascertained position of a second exit pupil produced simultaneously with the first exit pupil, in particular of the plurality of second exit pupils. The first and second exit pupils that are simultaneously produced as pairs A, A′ or B, B′ in a simple replication can thus each be represented as a gray image, for example, wherein the first exit pupils are represented differently than the second exit pupils. The differentiation between first and second exit pupils can in particular be made via a different intensity, in particular color intensity, of the first exit pupils in comparison to the second exit pupils. For this purpose, light beams of different infrared wavelength ranges can in particular be detected or used for the first and second exit pupils.

According to an example embodiment of the present invention, preferably, the redirection unit is designed to direct the second light beams onto the first exit pupils toward the eye of the user. The first and second light beams thus have the same light path from the redirection unit toward the user eye. The first exit pupils are thus formed by means of the first and second light beams, whereby the computing unit can ascertain the positions of the exit pupils more precisely.

According to an example embodiment of the present invention, preferably, the optical replication component is designed to direct the replicated second light beams onto the second exit pupils toward the eye of the user. The first and second light beams thus have the same light path from the optical replication component toward the user eye. The second exit pupils are thus formed by means of the first and second light beams, whereby the computing unit can ascertain the positions of the second exit pupils more precisely. The differentiation between first and second exit pupils is made via the signal evaluation. In particular, intensities, measured in this context, of the first and second exit pupils can be used. First and second exit pupils simultaneously entering the pupil produce a different change in intensity than a solely entering first or second exit pupil. Preferably, in this context, the optical replication component is furthermore designed to scan the third light beams over, in particular the entire area of, an eye region including the pupil of the user. The advantage here is that a relative position and orientation of the individual exit pupils to one another and to the eye can still be determined by means of the third light beams. In this context, only the first sensor is preferably used to detect the second and third light beams. A bandpass filter upstream of the first sensor can be designed to allow both IR wavelength ranges to pass through unattenuated. The first and second exit pupils that do not reach the retina in this case are displayed as bright spots. The first and second exit pupils that enter the pupil and then impinge on the retina disappear in the image. Alternatively, the first sensor is designed to detect the backscattered second light beams, and the second sensor is designed to detect the backscattered third light beams. In this case, the fusion or summation of the two results, in particular in a common image, takes place at a later time.

Alternatively, according to an example embodiment of the present invention, the optical replication component is designed to direct the third light beams onto the second exit pupils toward the eye of the user. The first and third light beams thus have the same light path from the optical replication component toward the user eye. The second exit pupils are thus formed by means of the first and third light beams, whereby the computing unit can ascertain the positions of the second exit pupils more precisely. In particular, by using light beams of different infrared wavelengths, a differentiation between first and second exit pupils can be made simply, in particular visually.

Preferably, according to an example embodiment of the present invention, the first and/or the second sensor are designed as photodiodes.

Preferably, according to an example embodiment of the present invention, the projector unit is designed to combine the first and second light beams into a common light beam. Alternatively, the projector unit is designed to combine the first, second and third light beams into a common light beam.

Preferably, according to an example embodiment of the present invention, the redirection unit is designed as a first holographic optical element, in particular layer. Furthermore, the optical replication component is designed as a second holographic optical element, in particular layer. In this case, the first and second holographic optical elements are stacked, in particular stacked one above the other. Alternatively, the redirection unit and the optical replication component are formed as an, in particular common, third holographic optical element, in particular layer. The third holographic optical element has a first redirection function, which directs the projected image content and the second light beams toward the eye of the user. Furthermore, the third holographic optical element has a second redirection function, which directs the projected image content and the second light beams in a replicated manner toward the eye of the user. Alternatively or additionally, the second redirection function is used to direct the projected image content and the third light beams toward the eye of the user. Such a holographic optical element is also referred to as a multiplexing HOE.

Preferably, according to an example embodiment of the present invention, the image processing device is designed depending on the ascertained positions of the first exit pupils relative to the pupil center and the therefrom-differentiated ascertained positions of the second exit pupils relative to the pupil center, to produce subimage data from the image data such that only one exit pupil produced on a common imaging path, in particular with the same image data, is always imaged on a retina of the user. In particular, the subimage data comprise copies or (distorted, partially blanked, shifted, rotated or otherwise scaled) versions of the image content. Double images are thus prevented from being produced on the retina of the user, since the user is shown the same image content at the same time only once.

Preferably, according to an example embodiment of the present invention, the optical system is designed as a pair of smart glasses.

A further subject matter of the present invention is a method for projecting image contents onto the retina of a user with the aid of an optical system. According to an example embodiment of the present invention, the optical system is in particular the optical system described above. The optical system comprises an image source, which provides image content in the form of image data. Additionally, the optical system comprises an image processing device for the image data. In addition, the optical system comprises a projector unit with a time-modulatable first light source for generating at least one first light beam and with a controllable deflection device for the at least one first light beam for scanning projection of the image content. The projector unit additionally compromises a second light source for generating at least one second light beam in a first infrared wavelength range. The controllable deflection device is designed in this context to deflect the at least one second light beam in a scanning manner. Alternatively or additionally, the projector unit comprises a third light source for generating at least one third light beam in a second infrared wavelength range different from the first infrared wavelength range. The controllable deflection device is designed in this context to deflect the at least one third light beam in a scanning manner. The optical system furthermore comprises a redirection unit, onto which the image content is projected and which directs the projected image content and the second light beams toward an eye of a user. Also provided are an optical segmentation element, which is arranged between the projector unit and the redirection unit, and an optical replication component, which is arranged in a projection area of the redirection unit. Furthermore, the optical system comprises a first sensor. Alternatively or additionally, the optical system comprises a second sensor. The optical system also comprises a computing unit. In the method for projecting image contents onto the retina of a user, the image content and the second light beams are first projected with the aid of the optical segmentation element via different imaging paths onto at least one projection area of the redirection unit so that, in particular at different times, a plurality of spatially-offset first exit pupils is produced. Alternatively or additionally, the image content and the second light beams are projected with the aid of the optical segmentation element via different imaging paths onto the at least one projection area of the redirection unit so that, in particular at different times, the plurality of spatially-offset first exit pupils is produced. In both cases, at least individual imaging paths are controlled individually.

Furthermore, the projected image content is replicated with the aid of the optical replication component and directed, spatially-offset, toward the eye of the user so that, in particular at different times, a plurality of spatially-offset second, replicated exit pupils is produced with the image content. Additionally, the second light beams are directed in a replicated manner toward the eye of the user with the aid of the optical replication component. Alternatively or additionally, the third light beams are directed in a replicated manner toward the eye of the user with the aid of the optical replication component. Furthermore, second light beams backscattered by an outer eye surface, in particular the iris or sclera, of the user, or a modulation of a power, in particular a laser power, of the second light source are detected with the aid of the first sensor. Alternatively or additionally, third light beams backscattered by the outer eye surface, or a modulation of a power, in particular a laser power, of the third light source are detected with the aid of the first sensor. Furthermore, alternatively or additionally, third light beams backscattered by the outer eye surface, or the modulation of the power, in particular the laser power, of the third light source are detected with the aid of the second sensor. In a further method step, the, in particular different, positions of the first exit pupils relative to a pupil center and the, in particular different, positions of the second exit pupils relative to the pupil center, are ascertained with the aid of the computing unit, depending on the backscattered second light beams detected by means of the first sensor or on the modulation of the power of the second light source. Alternatively or additionally, the, in particular different, positions of the first exit pupils relative to the pupil center and the, in particular different, positions of the second exit pupils relative to the pupil center are ascertained with the aid of the computing unit, depending on the backscattered third light beams detected by means of the first and/or second sensor or on the modulation of the power of the third light source. Furthermore, the ascertained positions of the ascertained first exit pupils relative to the pupil center are differentiated from the ascertained positions of the ascertained second exit pupils relative to the pupil center by means of the computing unit, in particular for the image processing taking place by means of the image processing device.

According to an example embodiment of the present invention, preferably, with the aid of the image processing device, depending on the ascertained positions of the first exit pupils relative to the pupil center and the therefrom-differentiated ascertained positions of the second exit pupils relative to the pupil center, subimage data are produced from the image data such that only one exit pupil produced on a common imaging path, in particular with the same image data, is always imaged on a retina of the user.

### BRIEF DESCRIPTION OF THE DRAWINGS

FIG. 1 shows a first embodiment of an optical system for a virtual retinal scan display, according to the present invention.

FIG. 2 shows a second embodiment of the optical system for the virtual retinal scan display, according to the present invention.

FIG. 3 shows a third embodiment of the optical system for a virtual retinal scan display, according to the present invention.

FIG. 4 shows an arrangement of first and second exit pupils in an exit pupil plane of the user.

FIG. 5 shows a detected intensity of a first and second exit pupil.

FIGS. 6A to 6D show images of positions of first and second exit pupils.

FIG. 7A shows a first method for projecting image contents onto the retina of a user with the aid of an optical system, according to an example embodiment of the present invention.

FIG. 7B shows a second method for projecting image contents onto the retina of a user with the aid of an optical system, according to an example embodiment of the present invention.

### DETAILED DESCRIPTION OF EXAMPLE EMBODIMENTS

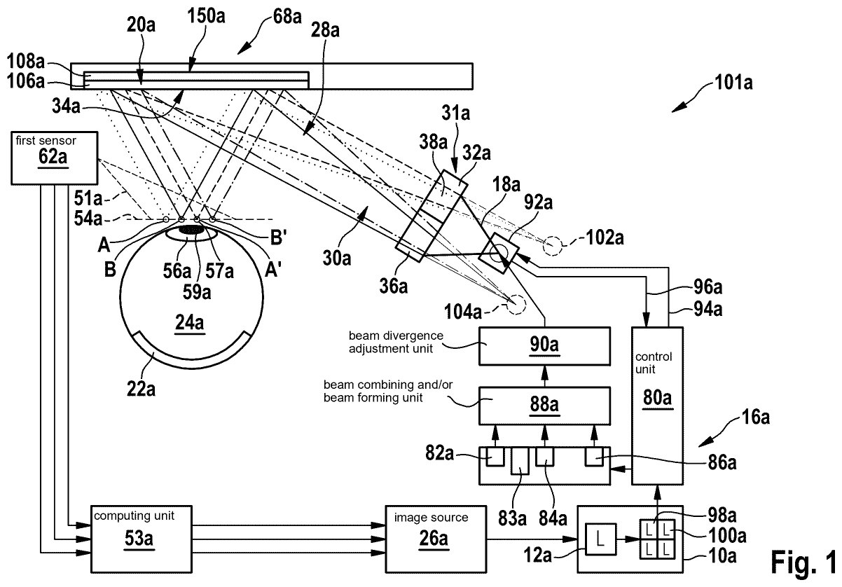

FIG. 1 schematically shows a first embodiment of an optical system 101a for a virtual retinal scan display. The optical system 101a comprises an image source 26a, which provides image content in the form of image data 12a. Additionally, the optical system 101a comprises an image processing device 10a for the image data 12a. In addition, the optical system 101a comprises a projector unit 16a with a time-modulatable light source 82a for generating at least one first light beam and with a controllable deflection device 92a for the at least one first light beam for scanning projection of the image content. The projector unit 16a additionally compromises a second light source 83a for generating at least one second light beam in a first infrared wavelength range. The controllable deflection device 92a, which in this exemplary embodiment constitutes at least one rotatably mounted micromirror, is designed to deflect the at least one second light beam in a scanning manner. In addition, the optical system 101a comprises a redirection unit 20a, onto which the image content is projectable and which is configured to direct the projected image content and the second light beams toward an eye 24a of a user. The optical system 101a furthermore comprises an optical segmentation element 31a, which is arranged between the projector unit 16a and the redirection unit 20a and with the aid of which the image content and the second light beams are projectable via different imaging paths 28a and 30a onto at least one projection area 34a of the redirection unit 20a so that, in particular at different times, a plurality of spatially-offset first exit pupils A and B is produced. In this exemplary embodiment, the first exit pupils A and B are represented in the exit pupil plane 54a. The different imaging paths 28a and 30a are produced starting from the different virtual micromirror positions 102a and 104a and are individually controllable. In this exemplary embodiment, the redirection unit 20a is used to direct the second light beams likewise onto the first exit pupils A and B toward the eye 24a of the user. In addition, the optical system 101a comprises an optical replication component 150a, which is arranged in the at least one projection area 34a of the redirection unit 20a and is configured to direct the projected image content in a replicated manner toward the eye 24a of the user so that, in particular at different times, a plurality of spatially-offset second, replicated exit pupils A′ and B′ is produced with the image content. In this exemplary embodiment, the second exit pupils A′ and B′ are represented in the exit pupil plane 54a. The optical replication component 150a is additionally designed to direct the second light beams in a replicated manner toward the eye 24a of the user. In this exemplary embodiment, the optical replication component 150a is used to direct the replicated second light beams likewise onto the second exit pupils A′ and B′ toward the eye 24a of the user. Furthermore, the optical system 101a comprises a first sensor 62a designed to detect second light beams 51a backscattered by an outer eye surface 56a of the user, or a modulation of a power, in particular a laser power, of the second light source 83a. Additionally, the optical system 101a comprises a computing unit 53a designed to ascertain the different positions of the first exit pupils A and B relative to a pupil center 59a and the different positions of the second exit pupils A′ and B′ relative to the pupil center 59a, depending on the backscattered second light beams 51a detected by means of the first sensor 62a or on the modulation of the power of the second light source 83a. Additionally, the computing unit 53a is used to differentiate the ascertained positions of the ascertained first exit pupils A and B relative to the pupil center 59a from the ascertained positions of the ascertained second exit pupils A′ and B′ relative to the pupil center 59a, in particular for the image processing taking place by means of the image processing device 10a.

In this exemplary embodiment, the first sensor 62 is designed as a photodiode.

The projector unit 16a is used in particular to combine the first and second light beams into a common light beam 18a.

The optical segmentation element 31a in this exemplary embodiment is designed as an optical segmentation lens with at least two segments 32a and 36a.

In the illustrated exemplary embodiment, the first light source 82a is designed to emit a first red laser beam. Furthermore, the projector unit 16a comprises a fourth light source 84a for generating a green laser beam and a fifth light source 86a for generating a blue laser beam. In this case, all light sources are designed as laser diodes. The projector unit 16a furthermore comprises a beam combining and/or beam forming unit 88a. The beam combining and/or beam forming unit 88a is configured to combine, in particular blend, the different-colored laser beams of the laser diodes 82a, 84a, 86a to produce a color image. The beam combining and/or beam forming unit 88a is configured to form the common light beam 18a, in particular the laser beam, exiting the projector unit 16a. Details on the design of the beam combining and/or beam forming unit 88a are presumed to be described in the related art. The projector unit 16a furthermore comprises a beam divergence adjustment unit 90a. The beam divergence adjustment unit 90a is provided to adjust a beam divergence of the common light beam 18a, in particular laser beam, exiting the projector unit 16a, preferably to a path length of the respective currently-emitted beam 18a, which in particular depends on an arrangement of optical elements of the optical system 68a. Furthermore, a control unit 80a for the controllable deflection device 92a is provided in this exemplary embodiment. This control unit 80a sends control signals 94a to the controllable deflection device 92a and receives, in particular current, position signals 96a of the controllable deflection device 92a.

In this first exemplary embodiment, the redirection unit 20a is designed as a first holographic optical element 106a, in particular layer, and the optical replication component 150a is designed as a second holographic optical element 108a, in particular layer. The two HOEs are stacked in this case.

Optionally, the image processing device 10a is designed depending on the ascertained positions of the first exit pupils A and B relative to the pupil center 59a and the therefrom-differentiated ascertained positions of the second exit pupils A′ and B′ relative to the pupil center 59a, to produce subimage data 98a and 100a from the image data 12a such that only one exit pupil A or A′ and B or B′ produced on a common imaging path 28a or 30a, in particular with the same image data, is always imaged on a retina 22a of the user.

Optionally, the optical system 101a is designed as a pair of smart glasses, on the frame or temple (not shown) of which the different components are arranged. The redirection unit 20a and the optical replication component 150a are integrated into a lens 68a, in particular of the pair of smart glasses, in this exemplary embodiment.

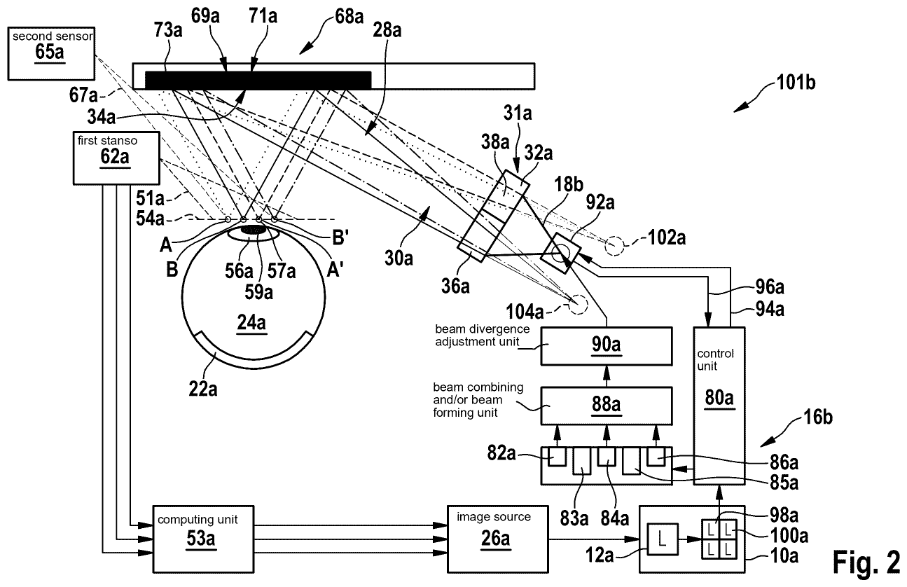

FIG. 2 schematically shows a second exemplary embodiment of the optical system 101b for a virtual retinal scan display. In contrast to the first exemplary embodiment, the projector unit 16b additionally comprises a third light source 85a for generating at least one third light beam in a second infrared wavelength range different from the first infrared wavelength range. The controllable deflection device 92a is designed to deflect the third light beam likewise in a scanning manner. The projector unit 16b or its beam combining and/or beam forming unit 88a is designed to combine the first, second and third light beams into a common light beam 18b.

The optical segmentation element 31 arranged between the projector unit 16b and the redirection unit 69a is designed to project the image content, the second light beams and the third light beams via the different imaging paths 28a and 30a onto the at least one projection area 34a of the redirection unit 69a so that, in particular at different times, the plurality of spatially-offset first exit pupils A and B is produced. In contrast to the first embodiment, the redirection unit 69a and the optical replication component 71a are furthermore designed as a third holographic optical element 73a, in particular layer. The third holographic optical element 73a has a first redirection function, which directs the projected image content and the second light beams onto the first exit pupils A and B toward the eye 24a of the user. The third holographic optical element 73a furthermore has a second redirection function, which directs the projected image content and the third light beams onto the second exit pupils A′ and B′ toward the eye 24a of the user.

Furthermore, in contrast to the first exemplary embodiment, the optical system 101b comprises a second sensor 6 designed to detect the third light beams 67a backscattered by the outer eye surface 56a, or the modulation of the power, in particular the laser power, of the third light source 85a.

The computing unit 53a is used to ascertain the, in particular different, positions of the first exit pupils A and B relative to the pupil center 59a and the, in particular different, positions of the second exit pupils A′ and B′ relative to the pupil center 59a, depending on the backscattered second light beams 51a detected by means of the first sensor 62a or on the modulation of the power of the second light source 83a and depending on the backscattered third light beams 67a detected by means of second sensor 65a or on the modulation of the power of the third light source 85a. Additionally, the computing unit 53a is used to differentiate the ascertained positions of the ascertained first exit pupils A and B relative to the pupil center 59a from the ascertained positions of the ascertained second exit pupils A′ and B′ relative to the pupil center 59a.

The second sensor 65a is designed as a photodiode in this exemplary embodiment as well.

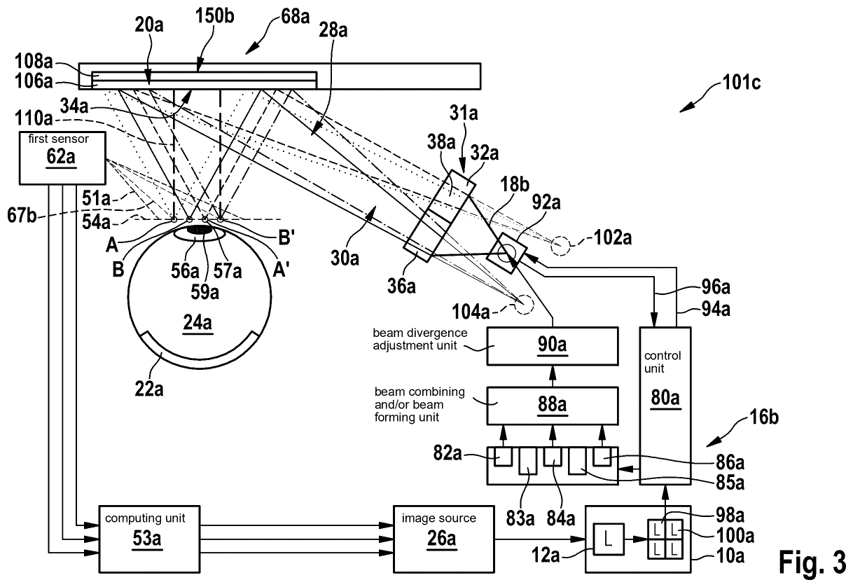

FIG. 3 schematically shows a third exemplary embodiment of the optical system 101c for a virtual retinal scan display. In contrast to the first embodiment, the additional third light source 85a is provided for generating the at least one third light beam in the second infrared wavelength range different from the first infrared wavelength range. While, analogously to FIG. 1, the redirection unit 20b and the optical replication component 150b direct the second light beams and the replicated second light beams onto the first exit pupils A and B and second exit pupils A′ and B′, an additional redirection function, which scans the third light beams over the entire area of the pupil 57a of the user, is integrated into the optical replication component 150b. The first sensor 62a in this third exemplary embodiment is designed to detect both the second light beams 51a backscattered by the outer eye surface 56a and the third light beams 67b backscattered by the outer eye surface 56a.

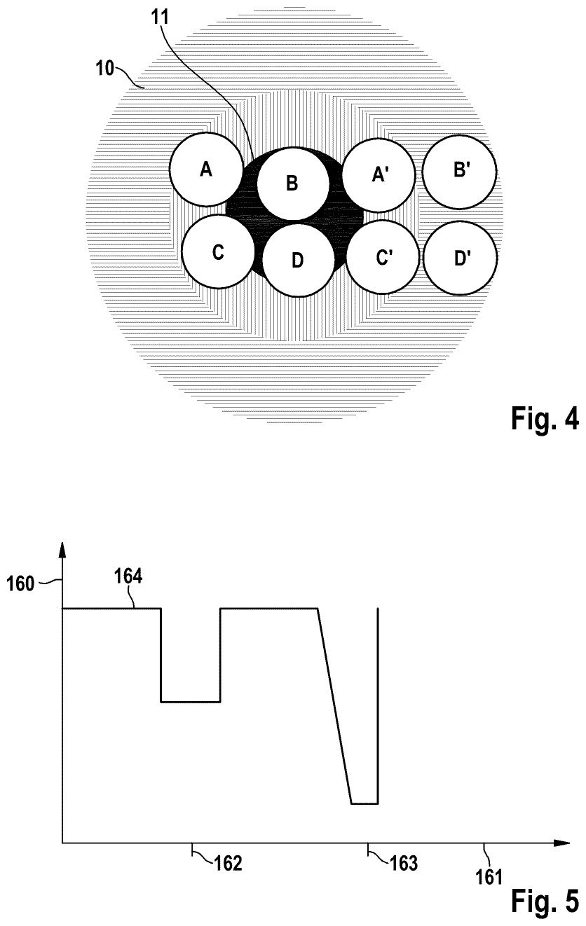

FIG. 4 schematically shows an exemplary arrangement of first exit pupils A, B, C and D and second exit pupils A′, B′, C′ and D′ in an exit pupil plane 10 of the user. The exit pupils A, A′, B, B′ C, C′, D and D′ are in this case distributed, offset in a pattern, in particular a grid. The term “grid” is understood in particular to mean a regular pattern distributed on an area. As can be seen in FIG. 4, the first exit pupils B and D almost completely enter the pupil 11 of the user, while the simultaneously-produced second exit pupils B′ and D′ are reflected by the iris (not shown here) of the user and thus do not reach the retina of the user. The simultaneously-produced first exit pupil A and second exit pupil A′ are arranged at least partially in the pupil of the user 11. In addition, the simultaneously-produced first exit pupil C and second exit pupil C′ are arranged at least partially in the pupil 11 of the user. In both cases, double images may be produced for the user, which is why differentiating the first exit pupils A, B, C and D from the second exit pupils A′, B′, C′ and D′ is advantageous.

FIG. 5 shows, for the arrangement of the exit pupils A, A′, B, B′ C, C′, D and D′, an example of a signal detection of the simultaneously-produced first exit pupil A and second exit pupil A′. The intensity is plotted on the Y-axis 160, and the time is plotted on the X-axis 161.

At a first time point 162, only the first exit pupil A enters the pupil, while the second exit pupil A′ does not enter the pupil. The measured intensity 164 thus decreases. At a subsequent time point 163, the eye turns and, in addition to the first exit pupil A, at least a portion of the second exit pupil A′ now also enters the pupil of the user eye. Due to the simultaneous entry of the exit pupils A and A′, the measured intensity 164 decreases more sharply than at the first time point 162.

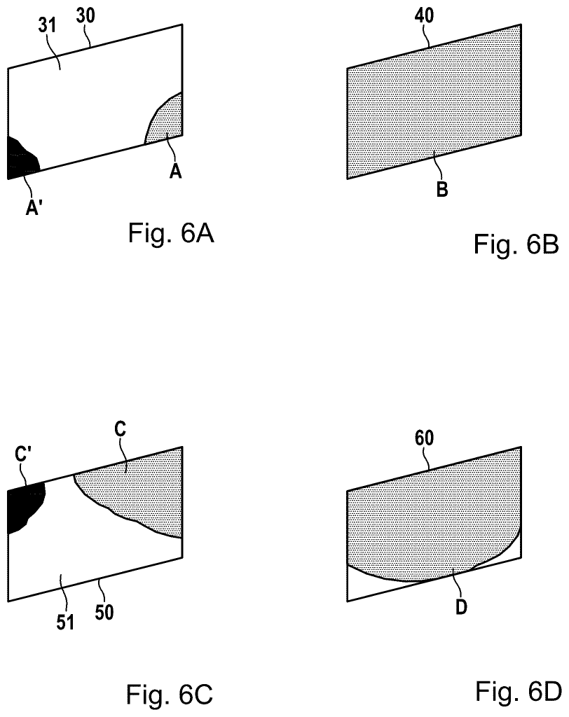

FIG. 6A shows, according to the arrangement of the exit pupils A and A′ in FIG. 3, a first image 30, created at a first time point, for the position of the first exit pupil A, as ascertained on the basis of the backscattered second and/or third light beams, in comparison to the ascertained position of the second exit pupil A′ produced simultaneously with the first exit pupil A. No second and/or third light beams have entered the pupil of the user in the areas 31. The exit pupils A′ and A thus only partially reach the retina of the user. For differentiating the first exit pupil A from the second exit pupil A′, the exit pupils A and A′ have a different gray level.

FIG. 6B shows, according to the arrangement of the exit pupils B and B′ in FIG. 3, a second image 40, created at a second time point following the first time point, for the position of the first exit pupil B, as ascertained on the basis of the backscattered second and/or third light beams. In this case, the first exit pupil B reaches the entire area of the retina of the user, while the associated second exit pupil B′ is completely reflected by the iris.

FIG. 6C shows, according to the arrangement of the exit pupils C and C′ in FIG. 3, a third image 50, created at a third time point following the second time point, for the position of the first exit pupil C, as ascertained on the basis of the backscattered second and/or third light beams, in comparison to the ascertained position of the second exit pupil C′ produced simultaneously with the first exit pupil C. No second and/or third light beams have entered the pupil of the user in the areas 51. The exit pupils C′ and C thus only partially reach the retina of the user. For differentiating the first exit pupil C from the second exit pupil C′, the exit pupils C and C′ have a different gray level in this case as well.

FIG. 6D again shows, according to the arrangement of the exit pupils D and D′ in FIG. 3, a fourth image 60, created at a fourth time point following the third time point, for the position of the first exit pupil D, as ascertained on the basis of the backscattered second and/or third light beams. In this case, the first exit pupil D reaches almost the entire area of the retina of the user, while the associated second exit pupil D′ is completely reflected by the iris.

In all cases, the computing unit is in particular designed to ascertain only the positions of the first exit pupils A, B, C and D and second exit pupils A′ and C′ that impinge on the retina of the user at the time of detecting the backscattered second light beams or the modulation of the power of the second light source and/or at the time of detecting the backscattered third light beams or the modulation of the power of the third light source.

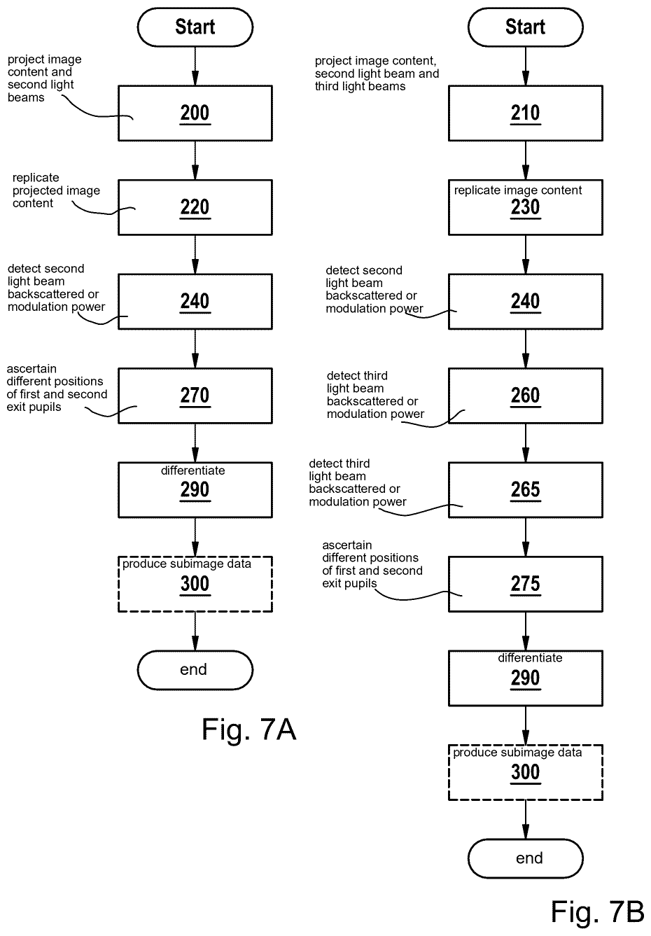

FIG. 7A shows a first method for projecting image contents onto the retina of a user with the aid of an optical system in the form of a flowchart. The optical system is in particular an optical system as shown in FIGS. 1 and 6.

In a first method step 200, the image content and the second light beams are projected with the aid of the optical segmentation element via different imaging paths onto at least one projection area of the redirection unit so that, in particular at different times, a plurality of spatially-offset first exit pupils is produced. At least individual imaging paths are controllable individually in this case. Furthermore, in a method step 220, the projected image content is replicated with the aid of the optical replication component and directed, spatially-offset, toward the eye of the user so that, in particular at different times, a plurality of spatially-offset second, replicated exit pupils is produced with the image content. Additionally, the second light beams are directed in a replicated manner toward the eye of the user with the aid of the optical replication component. In a subsequent method step 240, second light beams backscattered by the outer eye surface, or a modulation of a power, in particular a laser power, of the second light source are detected with the aid of the first sensor. In a subsequent method step 270, the, in particular different, positions of the first exit pupils relative to a pupil center and the, in particular different, positions of the second exit pupils relative to the pupil center, are ascertained with the aid of the computing unit, depending on the backscattered second light beams detected by means of the first sensor or on the modulation of the power of the second light source. In a subsequent method step 290, the ascertained positions of the ascertained first exit pupils relative to the pupil center are differentiated from the ascertained positions of the ascertained second exit pupils relative to the pupil center. Thereafter, the method ends.

In an optional method step 300 subsequent to the method step 290, with the aid of the image processing device, depending on the ascertained positions of the first exit pupils relative to the pupil center and the therefrom-differentiated ascertained positions of the second exit pupils relative to the pupil center, subimage data are produced from the image data such that only one exit pupil produced on a common imaging path, in particular with the same image data. is always imaged on a retina of the user.

FIG. 7B shows a second method for projecting image contents onto the retina of a user with the aid of an optical system in the form of a flowchart. The optical system is in particular an optical system as shown in FIG. 2.

In a first method step 210, the image content, the second light beams and the third light beams are projected with the aid of the optical segmentation element via different imaging paths onto at least one projection area of the redirection unit so that, in particular at different times, a plurality of spatially-offset first exit pupils is produced. At least individual imaging paths are controllable individually in this case. Furthermore, in a method step 230, the projected image content is replicated with the aid of the optical replication component and directed, spatially-offset, toward the eye of the user so that, in particular at different times, a plurality of spatially-offset second, replicated exit pupils is produced with the image content. Additionally, the third light beams are directed in a replicated manner toward the eye of the user with the aid of the optical replication component. In the subsequent method step 240, the second light beams backscattered by the outer eye surface, or the modulation of the power, in particular a laser power, of the second light source are detected with the aid of the first sensor. In a further method step 260, third light beams backscattered by the outer eye surface, or a modulation of a power, in particular a laser power, of the third light source are detected with the aid of the first sensor. Alternatively, in a method step 265, third light beams backscattered by the outer eye surface, or the modulation of the power, in particular the laser power, of the third light source are detected with the aid of a second sensor. In a subsequent method step 275, the, in particular different, positions of the first exit pupils relative to the pupil center and the, in particular different, positions of the second exit pupils relative to the pupil center are ascertained with the aid of the computing unit, depending on the backscattered second light beams detected by means of the first sensor or on the modulation of the power of the second light source and on third light beams backscattered by the outer eye surface or on a modulation of a power, in particular a laser power, of the third light source, or depending on the backscattered second light beams detected by means of the first sensor or on the modulation of the power of the second light source and on the backscattered third light beams detected by means of the second sensor or on the modulation of the power of the third light source. This is followed by the already described method step 300, and the method is ended.

1-15. (canceled)

16. An optical system for a virtual retinal scan display, comprising:
an image source which provides image content in the form of image data;
an image processing device for the image data;
a projector unit with a time-modulatable first light source configured to generate at least one first light beam and with a controllable deflection device for the at least one first light beam for scanning projection of the image content, and with a second light source configured to generate second light beams in a first infrared wavelength range, wherein the controllable deflection device is configured to deflect second light beams in a scanning manner;
a redirection unit, onto which the image content is projectable and which is configured to direct the projected image content and the second light beams toward an eye of a user;
an optical segmentation element, which is arranged between the projector unit and the redirection unit and using which the image content and the second light beams are projectable via different imaging paths onto at least one projection area of the redirection unit so that, at different times, a plurality of spatially-offset first exit pupils is produced, wherein at least individual imaging paths are individually controllable; and
an optical replication component, which is arranged in the at least one projection area of the redirection unit and is configured to direct the projected image content in a replicated manner toward the eye of the user so that, at different times, a plurality of spatially-offset second, replicated exit pupils is produced with the image content, wherein the optical replication component is additionally configured to replicate the second light beams toward the eye of the user;
a first sensor configured to detect second light beams backscattered by an outer eye surface of the user, or a modulation of a laser power of the second light source; and
a computing unit configured to, depending on the backscattered second light beams detected using the first sensor or on the modulation of the power of the second light source, to ascertain different positions of the first exit pupils relative to a pupil center, and different positions of second exit pupils relative to the pupil center, and to differentiate the ascertained positions of the ascertained first exit pupils relative to the pupil center and the ascertained positions of the ascertained second exit pupils relative to the pupil center, for image processing.

17. The optical system according to claim 16, wherein:
the projector unit includes a third light source configured to generate third light beams in a second infrared wavelength range different from the first infrared wavelength range, wherein the controllable deflection device is configured to deflect the at least one third light beam in a scanning manner;
the optical segmentation element is configured to project the image content, the second light beams, and the third light beams vis different imaging paths on the least at least one projection of the redirection unit so that, at the different times, the plurality of spatially-offset first exist pupils is produced;
the optical replication component is configured to direct the third light beams toward the eye of the user;
(i) the first sensor is configured to detect third light beams backscattered by the outer eye surface or a modulating of a laser power of the third light source and/or (ii) the optical system includes a second sensor configured to detect the third light beams backscattered by the outer eye surface or the modulating of the laser power of the third light source; and
the computing unit is configured to, depending on the backscattered second light beams detected using the first sensor or on the modulation of the power of the second light source and depending on the detected backscattered third light beams or on the modulation of the third light source, to ascertain the different positions of the first exit pupils relative to a pupil center, and the different positions of second exit pupils relative to the pupil center, and to differentiate the ascertained positions of the ascertained first exit pupils relative to the pupil center and the ascertained positions of the ascertained second exit pupils relative to the pupil center, for the image processing,

18. The optical system according to claim 17, wherein the computing unit is configured to ascertain the positions of only those of the first and second exit pupils that impinge on a retina of the user at a time of detecting the backscattered second light beams or the modulation of the power of the second light source and/or at a time of detecting the backscattered third light beams or the modulation of the power of the third light source.

19. The optical system according to claim 18, wherein the computing unit is additionally configured to ascertain a respective portion of the first and second exit pupils that impinges on the retina of the user at the time of detecting the backscattered second light beams or the modulation of the power of the second light source and/or at the time of detecting the backscattered third light beams or the modulation of the power of the third light source.

20. The optical system according to claim 16, wherein the computing unit is configured to represent the ascertained position of a first exit pupil of the first exit pupils differently in intensity in an image than the ascertained position of a second exit pupil of the second exit pupils produced simultaneously with the first exit pupil.

21. The optical system according to claim 16, wherein the redirection unit is configured to direct the second light beams onto the first exit pupils toward the eye of the user.

22. The optical system according to claim 17, wherein the optical replication component is configured to direct the replicated second light beams onto the second exit pupils toward the eye of the user.

23. The optical system according to claim 22, wherein the optical replication component is configured to scan the third light beams over an entire area of an eye region including the pupil of the user.

24. The optical system according to claim 17, wherein the optical replication component is configured to direct the third light beams onto the second exit pupils.

25. The optical system according to claim 17, wherein the first sensor and/or the second sensor are photodiodes.

26. The optical system according to claim 16, wherein the projector unit is configured to combine the first light beam and the second light beams into a common light beam.

27. The optical system according to claim 17, wherein the projection unit is configured to combine the first light beam, the second light beams, and the third light beams into a common light beam.

28. The optical system according to claim 16, wherein the redirection unit is a first holographic optical element layer, and the optical replication component is a second holographic optical element.

29. The optical system according to claim 17, wherein the redirection unit and the optical replication component are a third holographic optical element layer, wherein the third holographic optical element has a first redirection function, which directs the projected image content and the second light beams toward the eye of the user, wherein the third holographic optical element has a second redirection function, which replicates the projected image content and the second light beams and/or directs the third light beams toward the eye of the user.

30. The optical system according to claim 16, wherein the image processing device is configured to, depending on the ascertained positions of the first exit pupils relative to the pupil center and the differentiated ascertained positions of the second exit pupils relative to the pupil center, produce subimage data from the image data such that only one exit pupil produced on a common imaging path, the same image data, is always imaged on a retina of the user.

31. The optical system according to claim 16, wherein the optical system is a pair of smart glasses.

32. A method for projecting image contents onto a retina of a user using an optical system which includes:
an image source configured to provide image content in the form of image data,
an image processing device for the image data,
a projector unit with a time-modulatable first light source configured to generate at least one first light beam and with a controllable deflection device for the at least one first light beam for scanning projection of the image content, and with a second light source configured to generate second light beams in a first infrared wavelength range, wherein the controllable deflection device is configured to deflect the at least one second light beam in a scanning manner,
a redirection unit onto which the image content is projected and which directs the projected image content and the second light beams toward an eye of a user,
an optical segmentation element arranged between the projector unit and the redirection unit,
an optical replication component arranged in a projection area of the redirection unit,
a first sensor, and
a computing unit,
the method comprising the following steps:
projecting the image content and the second light beams using the optical segmentation element via different imaging paths onto at least one projection area of the redirection unit so that at different times, a plurality of spatially-offset first exit pupils is produced, wherein at least individual imaging paths the different imaging paths are individually controlled;
replicating the projected image content using the optical replication component and directing the replicated projected image content, spatially-offset, toward the eye of the user so that at different times, a plurality of spatially-offset second, replicated exit pupils is produced with the image content, and wherein the second light beams are replicated using the optical replication component and directed toward the eye of the user;
detecting the second light beams backscattered by an outer eye surface of the user, or a modulation of a laser power of the second light source using the first sensor;
ascertaining, using the computing unit, depending on the backscattered second light beams detected by the first sensor or on the modulation of the power of the second light source different, positions of the first exit pupils relative to a pupil center and different, positions of second exit pupils relative to the pupil center for image processing.

33. The method according to claim 32, wherein the projector unit includes a third light source configured to generate third light beams in a second infrared wavelength range different from the first infrared wavelength range, and the controllable deflection device is configured to deflect the third light beams in a scanning manner, wherein the third light beams are directed toward the eye of the user, wherein: (i) third light beams backscattered by the outer eye surface or a modulation of laser power of the third light source is detected using the first sensor and/or (ii) the third light beams backscattered by the outer eye surface or the modulation of the laser power of the third light source is detected using a second sensor of the optical system, and wherein the computing unit ascertains the positions of the first exit pupils relative to the pupil center and different, the positions of the second exit pupils relative to the pupil center for image processing, also depending on detected third light beams backscattered by the outer eye surface or the detected modulation of the laser power of the third light source.
